(19) United States
(12) Patent Application Publication
(10) Pub. No.: US 2015/0130678 A1
(43) Pub. Date: May 14, 2015

(54) MULTI-BAND GNSS FIXED RECEPTION PATTERN ANTENNA APPARATUS

(71) Applicant: ELECTRONICS AND TELECOMMUNICATIONS RESEARCH INSTITUTE, Daejeon (KR)

(72) Inventors: Dae Heon LEE, Daejeon (KR); Dong Hoon SHIN, Daejeon (KR); Jinchun WANG, Daejeon (KR); Hae Yong YANG, Daejeon (KR); Inho HWANG, Daejeon (KR); Chun Soo KIM, Daejeon (KR)

(21) Appl. No.: 14/483,383

(22) Filed: Sep. 11, 2014

(30) Foreign Application Priority Data
Oct. 30, 2013 (KR) 10-2013-0129953

(51) Int. Cl. H01Q 1/52; H01Q 5/20

(52) U.S. Cl. CPC H01Q 1/526; H01Q 5/20
USPC 343/841

(57) ABSTRACT

The present invention relates to a multi-band Global Navigation Satellite System (GNSS) fixed reception pattern antenna apparatus, which can mitigate interference signals using spatial filtering by optimizing the radiation pattern of an antenna. The multi-band GNSS fixed reception pattern antenna apparatus includes a broadband antenna radiator for receiving at least two types of GNSS signals, and a plurality of partition walls for enclosing the antenna radiator around the antenna radiator. Heights and intervals of each of the plurality of partition walls are independent of frequencies of signals desired to be blocked.

### CROSS REFERENCE TO RELATED APPLICATION

This application claims the benefit of Korean Patent Application No. 10-2013-0129953, filed on Oct. 30, 2013, which is hereby incorporated by reference in its entirety into this application.

### BACKGROUND OF THE INVENTION

1. Technical Field

The present invention relates generally to a multi-band GNSS fixed reception pattern antenna apparatus and, more particularly, to a multi-band GNSS fixed reception pattern antenna apparatus, which can mitigate interference signals using spatial filtering by optimizing the radiation pattern of an antenna.

2. Description of the Related Art

A Global Navigation Satellite System (GNSS), of which a Global Positioning System (GPS) is representative, denotes a satellite-based navigation system for measuring the exact time and location information of a user using information about the location, time, and additional error correction elements of a satellite. Currently, a GNSS is being variously utilized in ground, maritime, and air systems in both military and civil applications.

A GNSS system is freely available to the public. And GNSS satellites, which orbit at around 20,000 km, have a very weak signal. Therefore, a GNSS system is very vulnerable to unintentional electromagnetic interference such as multi-path interference, or intentional electromagnetic jamming. In particular, if a GNSS system for providing exact time information to national infrastructures such as mobile communications, financial systems, Digital Multimedia Broadcasting (DMB), and smart grids, is jammed, a serious problem would occur.

Recently, examples of damage caused by recent Global Positioning System (GPS) electromagnetic jamming by North Korea have been reported through the media. As described above, all national infrastructures in Korea, using a GPS, are vulnerable to GPS jamming. In the future, it is expected that damage will be sustained even by aerial jamming using airplanes or the like, as well as by horizontal jamming for transmitting jamming signals on land.

In this way, as conventional technology for mitigating jamming or radio interference that is a serious threat to a GNSS, there is a method of eliminating jamming signals using an array antenna. This technology is configured such that a plurality of antenna elements are spatially arranged and complex weights are assigned to each of outputs of the antenna elements, thus increasing signal strength in a desired direction and decreasing undesirable jamming signal strength.

Recently, there has been widely used a digital array antenna system in which signals received from antenna elements are converted into Intermediate Frequency (IF) signals via a down-converter, and Analog-to-Digital (A/D) conversion is performed on the IF signals, and then anti-jamming signal processing is implemented via a digital phase converter and a digital signal processor.

However, such a digital array antenna system is disadvantageous in that it requires a plurality of antenna elements, additional Radio Frequency (RF) components, and digital hardware, and also requires software having a nulling algorithm, so that a structure is complicated, and a lot of cost is required, and thus such a system is used only for military applications.

In civil applications, research into spatial filtering antennas based on the switching of a plurality of sector antennas and directional antennas using a shield have been conducted, but aerial jamming is not taken into consideration, and limited anti-jamming performance of 5 to 15 dB for horizontal jamming is exhibited. For example, Korean Patent Application Publication No. 2012-0059720 entitled “GPS antenna apparatus” discloses technology using a plurality of shielding layers so as to block horizontal jamming signals and multi-path signals. However, since the heights and intervals of shielding layers are dependent on the frequency of signal desired to be blocked, the above patent is disadvantageous in that it is valid only for a single-frequency jamming signal, and the heights and intervals of each of shielding layers cannot be freely selected.

### SUMMARY OF THE INVENTION

Accordingly, the present invention has been made keeping in mind the above problems occurring in the prior art, and an object of the present invention is to provide a multi-band GNSS fixed reception pattern antenna apparatus, which can mitigate interference signals using spatial filtering by optimizing the radiation pattern of an antenna.

In accordance with an aspect of the present invention to accomplish the above object, there is provided a multi-band Global Navigation Satellite System (GNSS) fixed reception pattern antenna apparatus, including a broadband antenna radiator for receiving at least two types of GNSS signals; and a plurality of partition walls for enclosing the antenna radiator around the antenna radiator, wherein heights and intervals of each of the plurality of partition walls are independent of frequencies of signals desired to be blocked.

The antenna radiator may be implemented as a broadband spiral antenna.

The plurality of partition walls may be configured such that a height of an innermost partition wall is a minimum, and heights of the partition walls are gradually decreased in a direction from a second innermost partition wall to an outer partition wall.

A number of the partition walls may be four.

The antenna radiator may be spaced apart from a ground plane by a preset distance.

The preset distance may be a distance set based on center wavelength.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an environment to which a multi-band GNSS fixed reception pattern antenna apparatus according to an embodiment of the present invention is applied;

FIG. 2 is a perspective view of a multi-band GNSS fixed reception pattern antenna apparatus according to an embodiment of the present invention;

FIG. 3 is a partial perspective view of the multi-band GNSS fixed reception pattern antenna apparatus according to an embodiment of the present invention;

FIG. 4 is a graph showing the Voltage Standing Wave Ratio (VSWR) of the multi-band GNSS fixed reception pattern antenna apparatus according to an embodiment of the present invention;

FIG. 5 is a graph showing the satellite signal reception performance of a commercial GPS antenna for 24 hours;

FIG. 6 is a diagram showing a sky view of GPS satellite signal reception for 24 hours performed by using the multi-band GNSS fixed reception pattern antenna apparatus and a u-blox receiver according to an embodiment of the present invention;

FIG. 7 is a graph showing the carrier to noise ratio (C/N0) of the u-blox receiver for 24 hours; and

FIG. 8 is a graph showing the number of tracked satellites of the u-blox receiver for 24 hours.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, a multi-band Global Navigation Satellite System (GNSS) fixed reception pattern antenna apparatus, which can mitigate interference signals using spatial filtering by optimizing the radiation pattern of an antenna, according to preferred embodiments of the present invention will be described in detail with reference to the attached drawings.

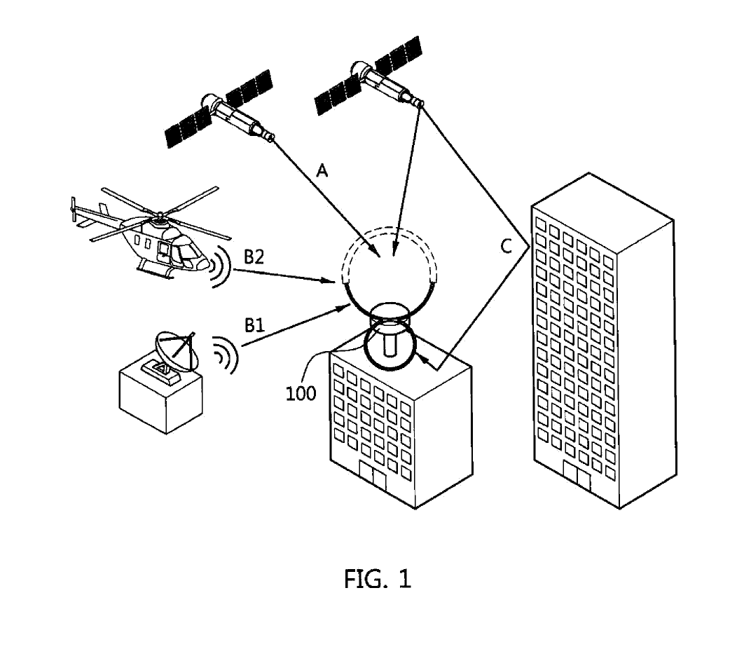

FIG. 1 is a diagram showing an environment to which a multi-band GNSS fixed reception pattern antenna apparatus according to an embodiment of the present invention is applied.

Referring to FIG. 1, a multi-band GNSS fixed reception pattern antenna apparatus 100 may block a horizontal jamming signal B1, a low altitude aerial jamming signal B2 incident at an elevation angle of 20° or less, and a multi-path signal C incident after being reflected from a building or the like, while receiving satellite signals A by optimizing a radiation pattern.

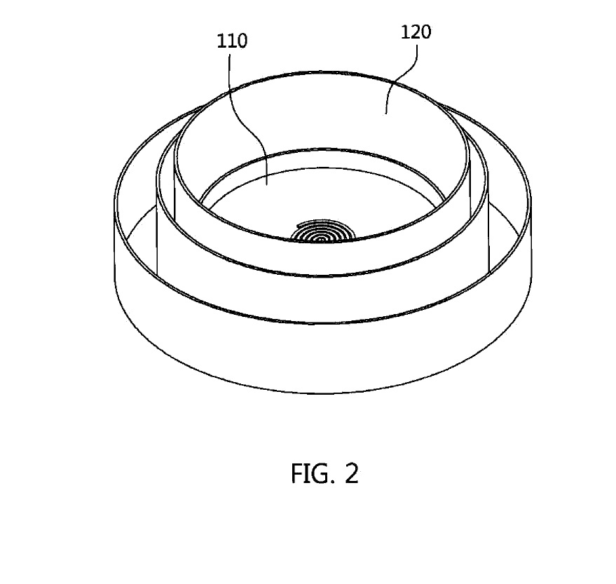

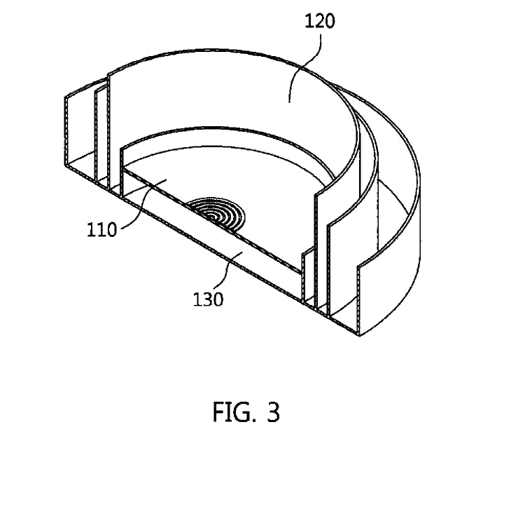

Below, the detailed configuration of the multi-band GNSS fixed reception pattern antenna apparatus 100 will be described with reference to FIGS. 2 and 3.

FIG. 2 is a perspective view of a multi-band GNSS fixed reception pattern antenna apparatus according to an embodiment of the present invention. Further, FIG. 3 is a partial perspective view of the multi-band GNSS fixed reception pattern antenna apparatus according to an embodiment of the present invention.

Referring to FIGS. 2 and 3, the multi-band GNSS fixed reception pattern antenna apparatus 100 includes an antenna radiator 110, a plurality of partition walls 120 having the shapes of concentric cylinders, and a ground plane 130.

The antenna radiator 110 is implemented as a broadband spiral antenna so as to receive two or more types of GNSS signals (for example, Global Positioning System (GPS) signals and Russian Global Navigation Satellite System (GLONASS) signals). Such an antenna radiator 110 is spaced apart from the ground plane 130 by a preset distance d. In this case, the preset distance d is represented by the following Equation (1):

$$d = \frac{λ}{4} \qquad ( 1 )$$

Referring to Equation (1), d denotes a distance between the antenna radiator 110 and the ground plane 130, and λ denotes the wavelength at center frequency.

Conventional shielding layers have a choke ring shape and a corrugated shape, and the heights and intervals of the shielding layers having such a shape are determined according to cutoff frequency. That is, the height of a choke ring-shaped shielding layer must be designed to be λ/4 of the cutoff frequency, and the height and the interval of a corrugated shielding layer are represented by the following Equation (2):

$$[ {k}^{2} - {( \frac{m π}{2 a} )}^{2} ] {d}^{2} = {n}^{2} {π}^{2} \qquad ( 2 )$$

Referring to Equation (2), k denotes a wave number, m and n are positive integers, a denotes the interval of the shielding layer, and d denotes the height of the shielding layer.

In this way, the conventional shielding layers are disadvantageous in that they are dependent on the frequency of a signal desired to be blocked, and thus the shielding layers are valid only for a single-frequency jamming signal, and in that the heights and intervals of each of shielding layers cannot be freely selected.

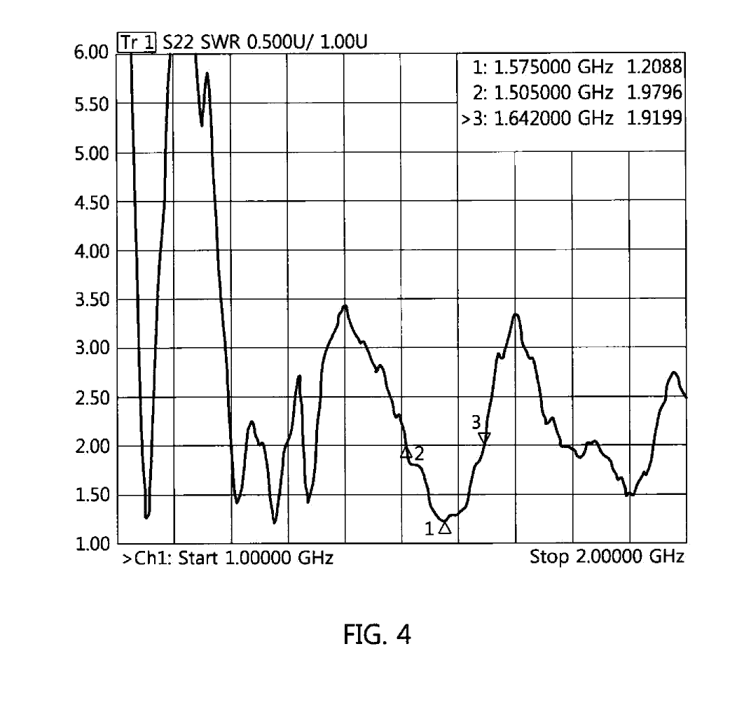

In contrast, in the multi-band GNSS fixed reception pattern antenna apparatus 100 according to the embodiment of the present invention, the heights and intervals of each of partition walls 120 may be designed independent of the frequency, as shown in FIG. 4.

In the case of the radiation pattern of a typical antenna, as the number of shielding layers is increased and the height of the shielding layers is greater, the pattern is narrowed, thus increasing the gain of the antenna. However, in this case, the size of the overall antenna is increased, and an increase in gain is limited, and thus the number and height of shielding layers must be suitably selected.

In the multi-band GNSS fixed reception pattern antenna apparatus 100 according to the embodiment of the present invention, the shielding layers are implemented as four partition walls 120, thus tracking four or more visible satellites while blocking jamming signals incident at an elevation angle of 20° or less and multi-path signals.

For this, the four partition walls 120 are designed such that the height of an innermost partition wall at the innermost location of the multi-band GNSS fixed reception pattern antenna apparatus 100 is a minimum, and the heights of the partition walls 120 are gradually decreased in a direction from the second innermost partition wall to the outer partition wall.

Below, the Voltage Standing Wave Ratio (VSWR) of the multi-band GNSS fixed reception pattern antenna apparatus 100 will be described in detail with reference to FIG. 4.

FIG. 4 is a graph showing the VSWR of the multi-band GNSS fixed reception pattern antenna apparatus according to an embodiment of the present invention.

Referring to FIG. 4, it can be seen that the multi-band GNSS fixed reception pattern antenna apparatus 100 satisfies a VSWR of 2:1 throughout the 1.505-1.650 GHz band, with the result that broadband characteristics of a relative bandwidth of 9.5% may be obtained. The reason for this is that the present invention uses a broadband spiral antenna other than a conventional resonant ceramic patch antenna as the antenna radiator 110.

Therefore, the multi-band GNSS fixed reception pattern antenna apparatus 100 according to the embodiment of the present invention may receive two or more types of GNSS signals.

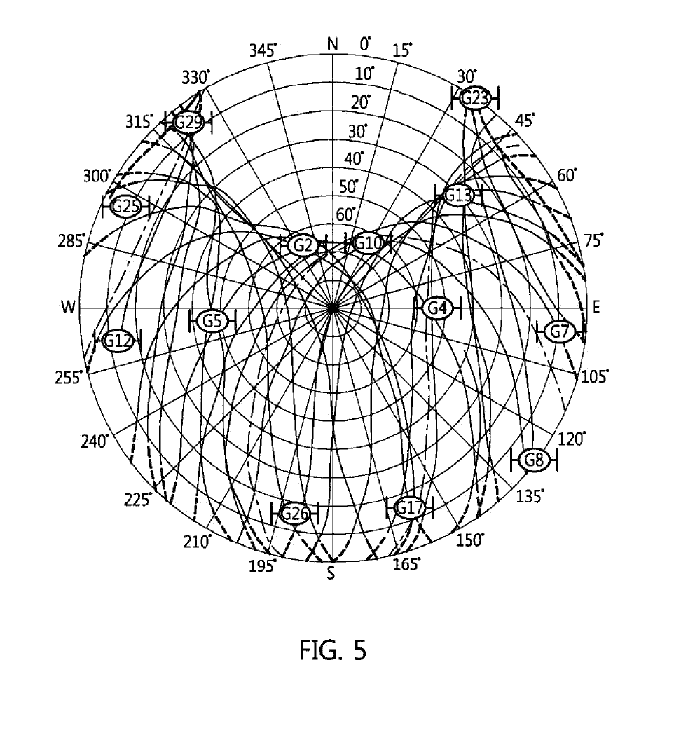

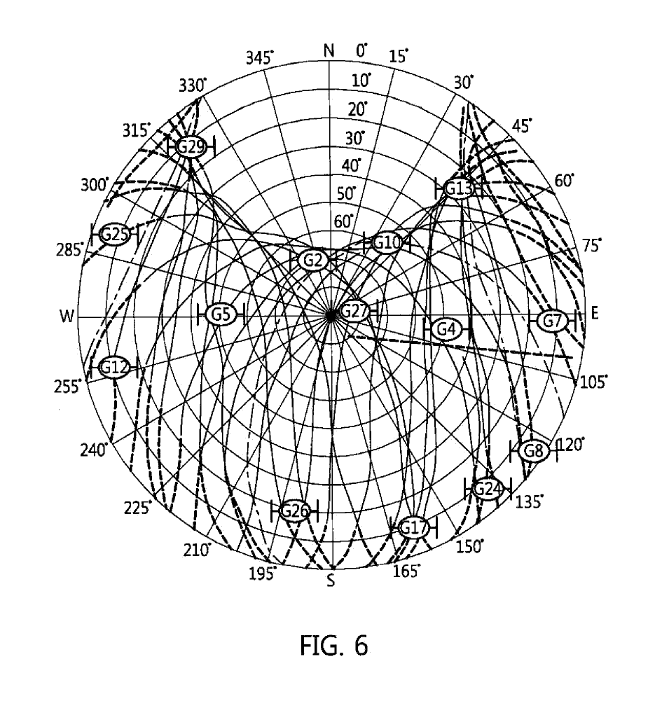

Below, the satellite signal reception performance of a commercial GPS antenna for 24 hours will be described in detail with reference to FIGS. 5 and 6.

FIG. 5 is a graph showing the satellite signal reception performance of the commercial GPS antenna for 24 hours.

In detail, FIG. 5 illustrates a sky view showing GPS satellite signal reception for 24 hours using the commercial GPS antenna and a u-blox receiver.

It can be seen that the commercial GPS antenna is tracking GPS satellites at an elevation angle of 10° or more while obtaining an average carrier to noise ratio (C/NO) of 32 dB-Hz or more for the GPS satellites. It is determined that, for the commercial GPS antenna, the results of FIG. 5 are derived because the radiation pattern of the antenna is designed in a hemispheric shape so as to receive as many satellite signals as possible.

Below, the satellite signal reception performance of the multi-band GNSS fixed reception pattern antenna apparatus 100 for 24 hours according to an embodiment of the present invention will be described in detail with reference to FIGS. 6 to 8.

FIG. 6 is a diagram showing a sky view of GPS satellite signal reception for 24 hours performed by using the multi-band GNSS fixed reception pattern antenna apparatus and a u-blox receiver according to an embodiment of the present invention.

Referring to FIG. 6, it can be seen that the multi-band GNSS fixed reception pattern antenna apparatus 100 according to the embodiment of the present invention may maximally suppress signals incident at an elevation angle of 20° or less, unlike FIG. 5. Further, it can also be seen that the present invention tracks GPS satellites at an elevation angle of 20° or more while obtaining an average carrier to noise ratio (C/N0) of 27 dB-Hz or more for the GPS satellites.

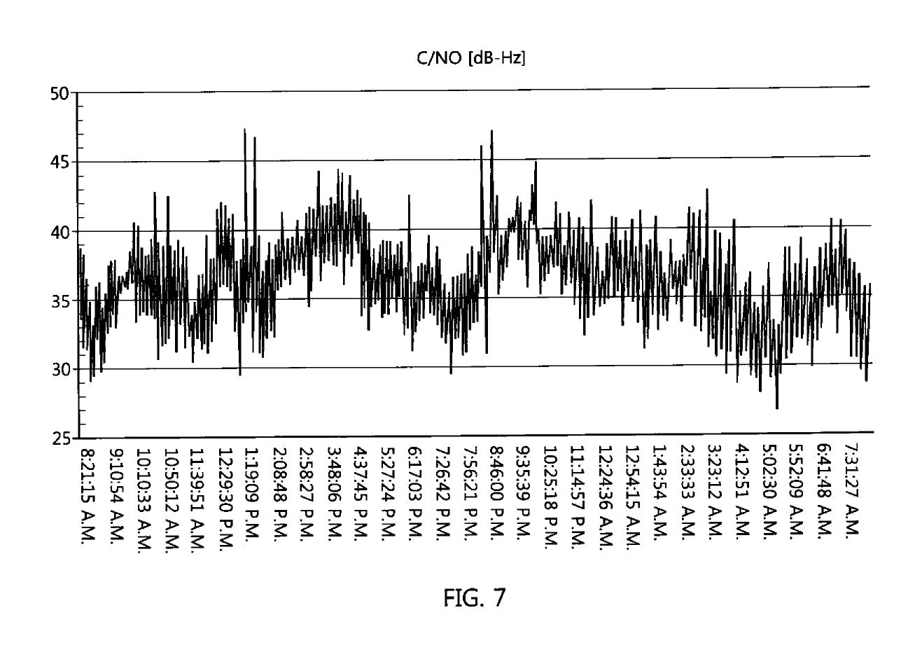

FIG. 7 is a graph showing the carrier to noise ratio (C/NO) of the u-blox receiver for 24 hours.

Referring to FIG. 7, it can be seen that the C/NO of the u-blox receiver for 24 hours is measured as an average of 37 dB-Hz.

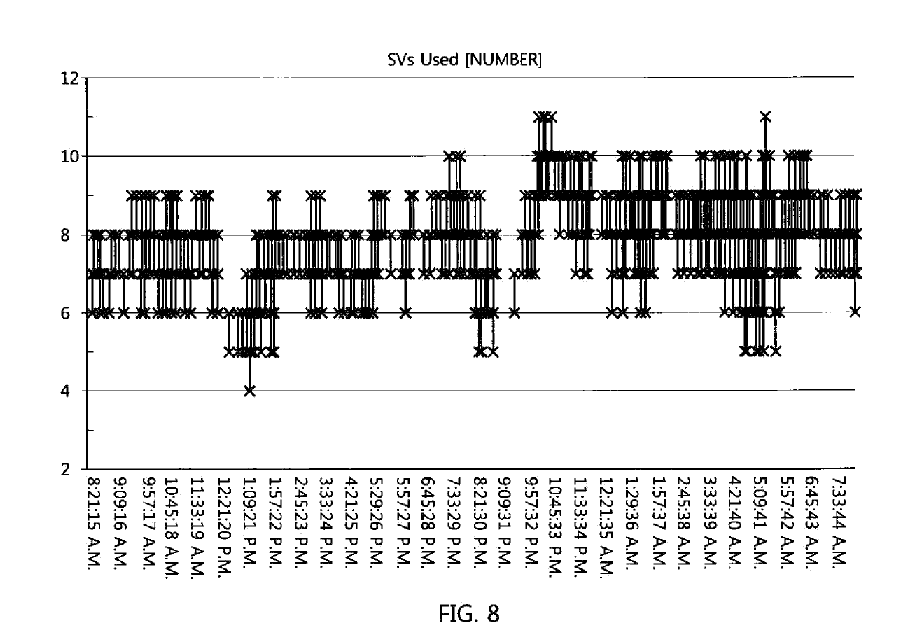

FIG. 8 is a graph showing the number of tracked satellites of the u-blox receiver for 24 hours.

Referring to FIG. 8, it can be seen that, for 24 hours, the u-blox receiver tracks a minimum of four satellites, a maximum of 11 satellites, and an average of 7.5 satellites.

In this way, the present invention relates to a multi-band GNSS fixed reception pattern antenna apparatus 100, which includes the broadband antenna radiator 110 configured to receive Right Handed Circularly Polarized (RHCP) signals and the plurality of partition walls 120 installed to concentrically enclose the antenna radiator 110 and configured to block multi-path signals incident behind the antenna radiator 110, jamming signals incident at a low-elevation angle, and horizontal jamming signals, so that the radiation pattern of the antenna is optimized via this structure, thus mitigating interference signals via spatial filtering.

In accordance with the present invention, there is an advantage in that, in the multi-band GNSS fixed reception pattern antenna apparatus, only several partition walls are configured independent of the frequencies of signals desired to be blocked, thus mitigating multi-band radio interference signals incident behind an antenna, low altitude aerial jamming signals, and horizontal jamming signals.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A multi-band Global Navigation Satellite System (GNSS) fixed reception pattern antenna apparatus, comprising:
a broadband antenna radiator for receiving at least two types of GNSS signals; and
a plurality of partition walls for enclosing the antenna radiator around the antenna radiator,
wherein heights and intervals of each of the plurality of partition walls are independent of frequencies of signals desired to be blocked.

2. The multi-band GNSS fixed reception pattern antenna apparatus of claim 1, wherein the antenna radiator is implemented as a broadband spiral antenna.

3. The multi-band GNSS fixed reception pattern antenna apparatus of claim 1, wherein the plurality of partition walls are configured such that a height of an innermost partition wall is a minimum, and heights of the partition walls are gradually decreased in a direction from a second innermost partition wall to an outer partition wall.

4. The multi-band GNSS fixed reception pattern antenna apparatus of claim 3, wherein a number of the partition walls is four.

5. The multi-band GNSS fixed reception pattern antenna apparatus of claim 1, wherein the antenna radiator is spaced apart from a ground plane by a preset distance.

6. The multi-band GNSS fixed reception pattern antenna apparatus of claim 5, wherein the preset distance is a distance set based on center wavelength.
